(19) United States
(12) Patent Application Publication
(10) Pub. No.: US 2026/0213339 A1
(43) Pub. Date: Jul. 23, 2026

(54) Battery Storage Device With a Safety Device, and Method for Triggering the Safety Device

(71) Applicant: Bayerische Motoren Werke Aktiengesellschaft, Muenchen (DE)

(72) Inventors: Alexander ADAM, Muenchen (DE); Roland JUNG, Muenchen (DE); Sebastian SCHARNER, Tuerkenfeld (DE); Thomas WOEHRLE, Muenchen (DE)

(21) Appl. No.: 18/714,963

(22) PCT Filed: Nov. 23, 2022
(86) PCT No.: PCT/EP2022/083016

§ 371 Date: May 30, 2024

(30) Foreign Application Priority Data
Dec. 10, 2021 (DE) 10 2021 132 746.6

(51) Int. Cl. H01M 50/392; H01M 10/0563; H01M 10/42; H01M 10/48; H01M 50/204; H01M 50/30; H01M 50/325; H01M 50/673

(52) U.S. Cl. CPC H01M 50/392; H01M 10/0563; H01M 10/4235; H01M 10/425; H01M 10/482; H01M 50/204; H01M 50/325; H01M 50/394; H01M 50/673; H01M 2200/00; H01M 2220/20

(57) ABSTRACT

A battery storage device includes a storage housing with at least one battery cell which is arranged in the interior of the storage housing and contains an electrolyte based on sulfur dioxide. The battery storage device has a safety device with a metering device which comprises an additive for neutralizing the electrolyte, and a switchable distribution device arranged in the interior of the storage housing for releasing the additive. The switchable distribution device can be selectively switched to a first or second metering stage, where the first metering stage involves the release of the additive within the distribution device, and the second metering stage involves the release of the additive outside of the distribution device and into the interior of the storage housing.

### BACKGROUND AND SUMMARY

The present invention relates to a battery storage device having a safety device and a method of triggering the safety device.

Electrochemical cells are of major importance in many technical fields. For example, electrochemical cells are frequently used for mobile applications, for example for the operation of laptops, E-bikes or cellphones. One advantage of electrochemical cells is that these can be connected to one another in series or in parallel in order to form batteries with a higher energy. Such batteries can be combined in what is called a battery storage device and are also suitable for use in high-voltage applications, among other things. For example, battery storage devices can enable the electrical driving of vehicles or be used as stationary energy storage devices.

The term “electrochemical cell” is used synonymously hereinafter for all names for rechargeable galvanic elements that are commonly used in the art, for example cell, battery, battery cell, accumulator, battery accumulator and secondary battery.

An electrochemical cell is capable of providing electrons for an external circuit in the discharge operation. Conversely, an electrochemical cell can be charged by the supply of electrons in the charging operation by means of an external circuit.

An electrochemical cell has at least two different electrodes: a positive electrode (cathode) and a negative electrode (anode). The two electrodes are in contact with a separator, which is an electrical insulator. An example of a prior art separator is a porous polyolefin separator impregnated with a liquid electrolyte composition. The separator spatially separates the two electrodes from one another and connects the two electrodes to one another in an ion-conducting manner.

The most commonly used electrochemical cell is the lithium ion cell, also called lithium ion battery. Lithium ion cells from the prior art typically have a composite anode that very frequently comprises a carbon-based active anode material, typically graphitic carbon, which is generally coated onto a metallic copper carrier foil with an electrode binder. The composite cathode typically comprises a porous active cathode material, for example a layered oxide, a binder and an electrical conductivity additive, applied, for example, to a rolled aluminum collector foil. The layered oxide very frequently comprises LiCoO₂ or LiNi_{1/3}Mn_{1/3}Co_{1/3}O₂.

Typically, lithium ion batteries have a liquid electrolyte composition that assures balancing of charge between the cathode and the anode in the charging and discharging operation. The current flow needed for the purpose is achieved by the ion transport of a conductive salt in the electrolyte composition. In the case of lithium ion cells, the conductive salt is a conductive lithium salt (e.g. LiPF₆, LiBF₄).

As well as the lithium salt, electrolyte compositions contain a solvent that enables dissociation of the conductive salt and sufficient mobility of the lithium ions. The prior art discloses liquid organic solvents that comprise a selection of linear and cyclic dialkyl carbonates. In general, mixtures of ethylene carbonate (EC), dimethyl carbonate (DMC), diethyl carbonate (EEC), propylene carbonate (PC) and ethyl methyl carbonate (EMC) are used. The solvents mentioned here each have a specific stability range in which they work stably under a given cell voltage. This range is also known as the voltage window. In the voltage window, the electrochemical cell can run stably during operation. In the case that the limits of the voltage window are approached, electrochemical oxidation or reduction of the constituents of the electrolyte composition will take place. The aim is therefore to use electrolytes that have higher stability to different cell voltages.

A further development of lithium ion batteries with an organic electrolyte is therefore lithium ion batteries having an inorganic electrolyte based on the solvent sulfur dioxide. The prior art discloses various approaches for stable electrolyte compositions based on sulfur dioxide.

EP 1 201 004 B1 discloses a rechargeable electrochemical cell with a sulfur dioxide-based electrolyte. Sulfur dioxide is not added here as an additive, but instead constitutes the main constituent as solvent for the conductive salt in the electrolyte composition. It should therefore at least partly assure mobility of the lithium ions of the conductive salt that bring about ion transport between the electrodes. In the cells proposed, lithium tetrachloroaluminate (LiAlCl₄) as lithium-containing conductive salt is used in combination with an active cathode material composed of a transition metal oxide, especially an intercalation compound, for example lithium cobalt oxide (LiCoO₂). The addition of a salt additive, for example an alkali metal halide such as lithium fluoride, sodium chloride or lithium chloride, to the sulfur dioxide-containing electrolyte composition would afford functioning and rechargeable cells.

EP 2534719 B1 describes a rechargeable lithium battery cell with a sulfur dioxide-based electrolyte in combination with lithium iron phosphate (LFP) as an active cathode material. A preferred conductive salt used in the electrolyte composition was lithium tetrachloroaluminate. In tests with cells based on these components, it was possible to demonstrate high electrochemical stability of the cells.

WO 2015/043573 A2 discloses a rechargeable electrochemical battery cell with a housing, a positive electrode, a negative electrode and an electrolyte containing sulfur dioxide and a conductive salt, wherein at least one of the electrodes contains a binder selected from the group consisting of binder A consisting of a polymer formed from monomeric structural units of a conjugated carboxylic acid or from the alkali metal, alkaline earth metal or ammonium salt of said conjugated carboxylic acid or from a combination thereof, and binder B consisting of a polymer based on monomeric styrene and butadiene structural units, or a mixture of binders A and B.

WO 2021/019042 A1 describes rechargeable battery cells with an active metal, a layered oxide as active cathode material and a sulfur dioxide-containing electrolyte. Because of the sparing solubility of many common conductive lithium salts in sulfur dioxide, a conductive salt of the formula M⁺[Z(OR)₄]⁻ was used in the cells, in which M represents a metal selected from the group consisting of alkali metal, alkaline earth metal and a metal of group 12 of the Periodic Table, and R is a hydrocarbyl radical. The alkoxy groups —OR are each bonded in a monovalent manner to the central atom, which may be aluminum or boron. In a preferred embodiment, the cells contain a perfluorinated conductive salt of the formula Li⁺[Al(OC(CF₃)₃)₄]⁻. Cells consisting of the components described show stable electrochemical performance in experimental studies. Moreover, the conductive salts, especially the perfluorinated anion, have surprising hydrolysis stability. Moreover, the electrolytes are said to be oxidation-stable up to an upper potential of 5.0 V. It has also been shown that cells having the electrolytes disclosed can be discharged or charged at low temperatures of down to −41° C.

Moreover, German patent application No. 10 2021 118 811.3, which was yet to be published at the priority date of the present application, discloses a liquid electrolyte composition based on sulfur dioxide for an electrochemical cell. The electrolyte composition comprises the following components: A) sulfur dioxide; B) at least one salt, where the salt contains an anionic complex with at least one bidentate ligand. The counterion of the anionic complex is a metal cation selected from the group consisting of alkali metals, alkaline earth metals and metals of group 12 of the Periodic Table. The central ion Z of the complex is selected from the group consisting of aluminum and boron. The bidentate ligand forms a ring together with the central ion Z and with two oxygen atoms bonded to the central ion Z and the bridge radical, where the ring contains a continuous sequence of 2 to 5 carbon atoms. In addition, an electrochemical cell, especially a lithium ion cell, having the abovementioned electrolyte composition has been proposed.

In addition, cells with an electrolyte based on sulfur dioxide are known from EP 3 703 161A1, EP 2 227 838B1, EP 2 742 551B1, EP 3 771 011A2, WO 2005/031908 A2 and WO 2014/121803A1, to which reference is made here.

In the event of a mechanical, electrical or thermal defect in the battery cells, especially lithium ion cells with an electrolyte composition based on sulfur dioxide, it may be the case that the cell is opened and hence electrolyte constituents are released from the cell, especially gaseous electrolyte constituents such as sulfur dioxide.

It is an object of this disclosure, in the event of such damage to a cell with an electrolyte based on sulfur dioxide, to prevent escape of the electrolyte into the environment.

The object may be achieved in accordance with the invention by a battery storage device having a storage device housing and a safety device, and at least one battery cell with an electrolyte based on sulfur dioxide according to the independent claim.

Advantageous embodiments of the battery storage device of the invention are specified in the dependent claims, which can selectively be combined with one another.

According to the disclosure, the object may be achieved by a battery storage device, preferably for mobile or stationary applications, wherein the battery storage device comprises a storage device housing with at least one battery cell which is disposed in an interior of the storage device housing and contains a sulfur dioxide-based electrolyte. The battery storage device has a safety device with a dosage device disposed in the interior of the storage device housing, where the dosage device comprises an additive for neutralizing the electrolyte and a switchable distributor device for release of the additive, which is selectively switchable into a first or second dosage state. The first dosage state comprises a release of the additive within the distributor device, and the second dosage state comprises a release of the additive outside the distributor device into the interior of the storage device housing.

Environmental influences or internal factors can lead to damage to the battery storage device and hence to release of the electrolyte based on sulfur dioxide. Depending on the severity of the damage, it is possible here to distinguish between local damage and damage with external effects.

Local damage refers to spatially delimited damage within the battery storage device, especially within the storage device housing. One example of local damage is a defective cell with escaping electrolyte in the storage device housing, which has been opened as a result of a mechanical, thermal or electrical cause.

By contrast, damage with external effects means comprehensive damage to the battery storage device as a whole or to the immediate spatial environment of the battery storage device. One example of damage with external effects would be damage to the battery storage device itself, especially storage device housing, or a damaged vehicle equipped with the battery storage device. The cause of such damage with external effects may, for example, be a collision with another physical object.

The basic concept of the technology is that the proposed battery storage device is able to distinguish between local damage and damage with external effects, and to take measures proportionate to the respective severity of damage. For this purpose, the proposed battery storage device has a safety device comprising a dosage device with a switchable distributor device. The switchable distributor device is capable of switching into a first or second dosage state depending on the damage that exists in the battery storage device.

The first dosage state constitutes a measure implemented by the safety device against the existence of local damage. The first dosage state releases the additive for neutralizing the electrolyte solely within the distributor device. The safety device thus responds to local damage with a local and hence spatially confined release of the additive.

The second dosage state is a measure implemented by the safety device against damage with external effects. If the safety device switches the distributor device into the second dosage state, the additive is released outside the distributor device into the interior of the storage device housing, especially into the entire interior of the storage device housing. In this way, the interior can be flooded with the additive, such that the cells come into contact with the additive within the storage device housing. A released electrolyte can be neutralized virtually immediately.

It is thus possible to achieve the technical advantage that the proposed battery storage device can react with various measures depending on the severity of damage that exists. This permits flexibility in the neutralization of a sulfur dioxide-based electrolyte escaping from a cell. For example, a battery storage device that has performed neutralization of the electrolyte with a first dosage state in the event of local damage is still capable of functioning. Because the release of the additive is merely locally confined, the other cells in the storage device housing are unaffected by the release. Therefore, such a battery storage device can remain in operation. In this case, it would solely be the defective cell affected that would be removed from the grid and hence isolated.

Neutralization of the electrolyte is understood here to mean chemical neutralization that converts the electrolyte constituents, especially sulfur dioxide, into more chemically stable and less chemically harmful (preferably non-toxic) compounds than SO₂.

The proposed battery storage device is preferably disposed in a vehicle and serves for electrical driving thereof. There may of course also be two or more battery storage devices disposed in one such vehicle. The battery storage device of the disclosure is not limited to mobile applications such as vehicles and may also be used for stationary operation. For example, the battery storage device of the disclosure can be used for storage of energy from solar installations and wind parks.

According to the disclosure, the battery storage device comprises a storage device housing with at least one battery cell, preferably two or more battery cells, disposed in the interior thereof. The battery cells may be interconnected within the storage device housing in order to provide higher voltage and energy. A battery cell means an electrochemical cell with a sulfur dioxide-based electrolyte. The battery cell is preferably a lithium ion cell.

The technology is not subject any further restriction in relation to the sulfur dioxide-based electrolyte composition. It is therefore possible to use any of the sulfur dioxide-based electrolyte compositions that are customary in the art.

In particular, a sulfur dioxide-based electrolyte means a liquid electrolyte composition containing sulfur dioxide as a constituent. The sulfur dioxide may be in liquid form, gaseous form or bound within a complex in the electrolyte compositions. Suitable examples of such electrolyte compositions are known from EP 1 201 004 B1, EP 2534719 B1, WO 2015/043573 A2, WO 2021/019042 A1, EP 3 703 161 A1, EP 2 227 838 B1, EP 2 742 551 B1, EP 3 771 011 A2, WO 2005/031908 A2 and WO 2014/121803 A1, and from German patent application No. 10 2021 118 811.3 which was yet to be published at the priority date of the present application, to which reference is made here.

In an advantageous aspect of the technology, the storage device housing may have an outflow opening which is closed by a safety seal. The outflow opening connects the interior of the storage device housing to the environment of the battery storage device for flow purposes. The distributor device may be disposed in the interior of the storage device housing and coupled to the outflow opening.

The safety seal is set up to clear the outflow opening on attainment of a predetermined positive pressure. For example, the safety seal may be designed as a pressure relief valve.

Known storage device housings typically already have a safety seal in the form of a pressure relief valve which is designed to compensate for any difference in pressure between the interior of the storage device housing and the external environment. This is advantageous especially when the air pressure of the external environment drops compared to the internal pressure of the battery storage device, for example when the storage device is used in mountainous regions at higher altitudes.

In a particularly advantageous configuration of the technology, the distributor device may be coupled to such an existing pressure relief valve. This especially results in the technical advantage that there is no need to install an additional safety seal in the storage device housing, and it is possible to use conventional storage device housings for the manufacture of the battery storage device of this disclosure. It may thus be possible both to simplify the manufacture of the battery storage device and to reduce production costs.

Since the distributor device may be coupled to the outflow opening, in the event of local damage, an electrolyte released from a defective battery cell may take an indirect route via the distributor device before it can leave the battery storage device via the outflow opening and escape into the environment.

The technical advantage may thus be achieved that an escaping electrolyte covers a very long distance before it leaves the battery storage device, and this distance also automatically leads through the distributor device. The electrolyte to be neutralized is contacted with the distributor device in this way without the use of further active measures, for example pumps.

In one configuration of the technology, the switchable distributor device has a dosage housing with an extraction chamber which is connected for flow purposes to the interior of the storage device housing by at least one opening. The extraction chamber comprises a roof having an internal distributor element for releasing the additive and a floor having a trapping element for collecting the additive released. In addition, the dosage housing has an external distributor element for releasing the additive outside the extraction chamber and into the interior of the storage device housing. In other words, in the first dosage state, the additive is released within the extraction chamber via an internal distributor element disposed in the roof, while, in the second dosage state, the additive is released into the interior of the storage device housing via an external distributor element.

By virtue of this embodiment, a switchable distributor device is proposed, which can be switched in a simple manner into a first or second dosage state.

In one configuration of the technology, the trapping element is preferably designed as a groove or a drain. The trapping element may selectively comprise an adsorbent that at least partly adsorbs the additive released and electrolyte constituents that have reacted therewith. The adsorbent may be disposed, for example, in the channel or in the drain. The technology is not subject to any further restriction in relation to the adsorbent. In principle, it is possible to use any of the prior art adsorbents that are capable of binding the additive and electrolyte constituents that have reacted therewith.

The adsorbent is preferably a solid adsorbent, more preferably a solid porous adsorbent. The adsorbent is especially preferably a sponge.

In a further configuration of the technology, the dosage device comprises a reservoir vessel containing the additive.

The reservoir vessel is preferably disposed outside the storage device housing. However, it is also conceivable that the reservoir vessel is disposed in the interior of the storage device housing. The reservoir vessel serves to store the additive before the actual release. The provision of a reservoir vessel containing the additive allows the additive to be stored spatially separately from the battery cells.

In a further aspect of the technology, the reservoir vessel may be connected for flow purposes to an outflow pump and a dosage pump. The reservoir vessel is preferably connected via an inflow conduit to the dosage pump and via a backflow conduit to the outflow pump. The dosage pump is connected via a first valve to the internal distributor element and via a second valve to the external distributor element, where the outflow pump is connected for flow purposes to the trapping element and the reservoir vessel.

The described embodiment of the dosage device may enable direct withdrawal of the additive for operation of the first and second dosage states from a single reservoir vessel. The first and second dosage states thus do not require separate vessels, which means that the battery storage device can have a more compact design.

In a first dosage state, the additive can be withdrawn from the reservoir vessel by the dosage pump and released within the extraction chamber via the first valve and the internal distributor element disposed in the roof, where gaseous electrolyte constituents based on sulfur dioxide are neutralizable by the additive released as they pass through the extraction chamber.

The additive released and the gaseous constituents based on sulfur dioxide react within the extraction chamber, preferably in an acid-base neutralization reaction. In this way, the extraction chamber, in the first dosage state, filters and neutralizes the gaseous constituents out of the atmosphere of the interior of the storage device housing without the interior itself or other intact battery cells coming into contact with the additive released. The extraction chamber thus provides a spatially confined reaction chamber in which a chemical reaction between the electrolyte and the additive can proceed in a controlled manner. Reaction products of the neutralization reaction, especially neutralized electrolyte constituents, can be collected by the trapping element together with the unconsumed additive and returned to the reservoir vessel via the outflow pump. This results in the technical advantage that, in the case of existence of local damage within the battery storage device, there is no need to fill the entire battery storage device with the additive. Furthermore, unconsumed additive can be reused by returning it to the battery storage device and is thus available for a further neutralization.

Especially in the case that the first dosage state is chosen, an escaping sulfur dioxide-based electrolyte can be neutralized locally and within the extraction chamber by the release of the additive. This means that the other battery cells of the battery storage medium are not affected. It is thus possible, after successful neutralization, for the battery storage device to remain in operation.

In the second dosage state, the additive can be conducted out of the reservoir vessel by means of the dosage pump and released into the interior of the storage device housing by the second valve and the external distributor element.

This may result in the advantage that the additive is released throughout the interior of the storage device housing within a short time interval. A sulfur dioxide-based electrolyte present in the interior can thus be neutralized over a large area. This is advantageous especially when the storage device housing has lost integrity as a result of damage with external effects and/or several battery cells have been opened in parallel. Preferably, in the second dosage state, the complete amount of the additive is released from the reservoir vessel. In the case that the second dosage state is chosen, the battery storage device cannot be used any further since the additive released is not returned back to the reservoir vessel. In other words, the second dosage state is the most extreme measure that can be chosen in the case of severe damage to the battery storage device.

According to this disclosure, the distributor device may release an additive for neutralizing the electrolyte that has escaped from a cell, especially the sulfur dioxide present in the electrolyte.

In one aspect of the disclosure, the additive may comprise a base. The technology is not subject to any further restriction in relation to the base. In general, it is possible to use any of the bases customary in the art for the additive.

For example, the base may be a porous natural lime.

The base is preferably selected from the group of the carbonates, hydrogen carbonates, oxides and hydroxides, and combinations thereof.

Carbonates used may be especially metal carbonates, preferably alkali metal and alkaline earth metal carbonates. Suitable examples of carbonates are barium carbonate, calcium carbonate, magnesium carbonate, potassium carbonate, sodium carbonate and zinc carbonate, and combinations thereof.

Hydrogencarbonates used may be especially metal hydrogencarbonates, preferably alkali metal and alkaline earth metal hydrogencarbonates. Suitable examples of hydrogencarbonates include calcium hydrogencarbonate, magnesium hydrogencarbonate, barium hydrogencarbonate, strontium hydrogencarbonate, sodium hydrogencarbonate and potassium hydrogencarbonate, and combinations thereof.

Oxides used may especially be metal oxides, preferably alkali metal and alkaline earth metal oxides. Suitable examples of oxides include lithium oxide, sodium oxide, potassium oxide, magnesium oxide, calcium oxide, strontium oxide and barium oxide, and combinations thereof.

Hydroxides used may be especially metal hydroxides, preferably alkali metal alkaline earth metal hydroxides. Examples of hydroxides especially include lithium hydroxide, sodium hydroxide, potassium hydroxide, calcium hydroxide, barium hydroxide, strontium hydroxide and zinc hydroxide, and combinations thereof.

In addition, the additive may comprise water. The base is preferably present in an aqueous solution.

In another aspect of the disclosure, the aqueous solution may be a solution saturated by the base. Because of the high base content, the saturated solutions have a particularly high ion concentration. The ion concentration (base concentration) preferably corresponds to the solubility product of the respective base. For that reason, the solutions remain liquid even below the freezing point of water. The saturated solutions are thus especially suitable for operation or use in a vehicle.

More preferably, the additive comprises a saturated aqueous solution of sodium carbonate, further preferably an aqueous solution of potassium carbonate or combinations thereof.

The providing of a base in an aqueous solution may enable chemical neutralization of the sulfur-dioxide-based electrolyte in the form of an acid-base neutralization. The sulfur dioxide present in the electrolyte dissolves especially efficiently in water and can therefore be absorbed particularly effectively by the additive. In this context, the solubility of sulfur dioxide in water is 39.4 liters at 20° C. per 1 liter of water. Sulfur dioxide reacts in water to give sulfurous acid, which can in turn react with the base present in a chemical neutralization reaction. The base can therefore convert the sulfur dioxide dissolved in the aqueous solution, especially in the form of sulfurous acid, to more stable and preferably non-toxic chemical compounds. For example, sulfur dioxide can be converted by carbonates to stable sulfites, sulfates and/or hydrogensulfites.

Furthermore, the base used may be non-toxic, may have good solubility in water and may be readily available. Moreover, the base in an aqueous solution is a liquid that can be stored inexpensively and, if required, released in a simple manner.

In another aspect of the disclosure, the safety device may have a monitoring unit, where the monitoring unit comprises a battery control system, a pre-crash sensor which is connected to the battery control system and is preferably disposed outside the storage device housing, and a sensor unit which is connected to the battery control system and is preferably disposed within the storage device housing.

The battery control system is preferably disposed outside the battery storage device. It is therefore conceivable that the battery control system monitors two or more battery storage devices.

In one embodiment, the sensor unit is selected from the group consisting of optical sensors and pressure, temperature and chemical sensors.

In one embodiment, the sensor unit is a spectroscopic gas sensor for detecting gaseous sulfur dioxide.

In a preferred embodiment, the spectroscopic gas sensor is a nondispersive infrared sensor.

If abnormal behavior in at least one battery cell occurs during battery operation, this can be recognized by the abovementioned sensor types. A rise in pressure or temperature or a change in atmosphere composition within the storage device housing can thus be detected by the sensor unit. A defect in a battery cell can thus be recognized directly and without delay.

In particular, a gas sensor that responds selectively to sulfur dioxide enables direct information about the presence of sulfur dioxide within the storage device housing. If the gas sensor detects sulfur dioxide in the atmosphere of the storage device housing, the sulfur dioxide-based electrolyte has escaped from the battery cell and the corresponding cell is thus defective.

The data detected by the sensor unit may be passed on to the battery control system connected to the sensor unit. Typically, the data transmitted to the battery control system are measurement data that have been collected within a particular time interval.

The embodiment is not limited in relation the selection of a pre-crash sensor. In principle, it is possible to use any of the pre-crash sensors customary in the art that are capable of detecting an impending collision with another object. Particular preference is given to using pre-crash sensors designed for the operation of vehicles.

In a further aspect of the disclosure, the pre-crash sensor is intended to detect an impending collision with another object, to collect data therefrom and to pass them on to the battery control system.

In a preferred embodiment, the sensor unit detects an electrolyte escaping from a battery cell and/or the pre-crash sensor detects an impending collision with another object, and data are created from both events and are passed on to the battery control system.

In a further aspect of the disclosure, the battery control system may be configured to receive data from the sensor unit and/or the pre-crash sensor and evaluate these with regard to a trigger or non-trigger scenario. The battery control system decides on the basis of the data obtained to trigger a trigger or non-trigger scenario. If the battery control system registers abnormal data, more specifically data at variance from the data to be expected, the battery control system may initiate a trigger scenario. Abnormal data may, for example, be abnormal parameters with regard to pressure, temperature, atmosphere composition within the storage device housing, or data from an impending collision with another physical object. If the data received by the sensor unit agree with the data to be expected, a non-trigger scenario is chosen.

In an advantageous embodiment, the battery control system is set up to classify a trigger scenario into different degrees of severity. In particular, the battery control system can actuate the dosage device and switch the switchable distributor device into a first or second dosage state with reference to the degree of severity. In the case of a non-trigger scenario, the status quo is maintained and the dosage device is not actuated.

The classification of the trigger scenario into different degrees of severity takes place with reference to various factors. Firstly, the battery control system decides whether there is merely local damage within the storage device housing, or else damage with external effects in the battery storage device. Local damage is rated as a relatively low degree of severity and leads to triggering of a trigger scenario with the first dosage state, whereas damage with external effects is rated as a relatively high degree of severity and leads to a trigger scenario with the second dosage state. For classification of the trigger scenario into different degrees of severity, the battery control system refers in particular to the data from the pre-crash sensor. The battery control system is thus also able to take account of a shortly impending collision and hence expected damage with external effects in the battery storage device. The trigger scenario with the second dosage state is preferably only triggered in the event of a particular severity of the shortly impending collision, such that, in the case of a gentle collision, the complete storage device is not unnecessarily flooded with the additive. For this purpose, a threshold value can be defined for the expected collision, which is stored in the battery control system and is regularly compared in the course of operation with the data received from the pre-crash sensor. The degree of severity from which the battery control system switches the distributor device into a first or second dosage state is fixed individually and depending on the design of the battery storage device and, if appropriate, the design of a vehicle equipped with the battery storage device of the disclosure.

The above-described process preferably takes place at regular time intervals. It is thus possible for the monitoring unit to monitor the battery cells and the storage device housing in real time, which means that damage can be detected. It is therefore also possible for the battery control system to take appropriate timely measures in accordance with the damage in order to release the additive for neutralizing an escaping electrolyte within the battery storage device. In other words, the safety device according to the disclosure that includes a dosage device and a monitoring unit may be an active safety system.

The invention further relates to a method of triggering a safety device for a battery storage device of the above type, wherein the method may comprise the following steps:
a) detecting escape of the electrolyte from a battery cell within the storage device housing by way of the sensor unit of the monitoring unit and/or recognizing an impending collision of a vehicle with a physical object by means of a pre-crash sensor,
b) assessing the data by way of the battery control system with regard to the existence of a trigger or non-trigger scenario,
c) recognizing a trigger scenario,
d) classifying the trigger scenario into different degrees of severity,
e) triggering the safety device by actuating the dosage device, such that the dosage device switches the switchable distributor device into a first or second dosage state, where the first dosage state releases the additive within the distributor device, and where the second dosage state releases the additive outside the distributor device into the interior of the storage device housing.

A safety device that works by the above-specified method can thus react immediately to an electrolyte escaping from a battery cell and take countermeasures. The sulfur dioxide-based electrolyte may therefore be reliably stopped from escaping to the environment.

The technology is described in detail hereinafter by working examples with reference to the appended drawings.

### BRIEF DESCRIPTION OF THE DRAWINGS

FIG. 1 is a schematic diagram of a battery storage device with a safety device;

FIG. 2 is a schematic diagram of the battery storage device from FIG. 1 in the case of a trigger scenario with a first dosage state;

FIG. 3 is a schematic diagram of the battery storage device from FIG. 1 in the case of a trigger scenario in a second dosage state;

FIG. 4 is a cross-sectional view of a distributor device in the case of a non-trigger scenario;

FIG. 5 is a cross-sectional view of a distributor device in the case of a trigger scenario with a second dosage state;

FIG. 6 is a cross-sectional view of a distributor device in the case of a trigger scenario in a first dosage state;

FIG. 7 shows a gas sensor for selective detection of sulfur dioxide in the battery storage device;

FIG. 8 is a schematic diagram of a suitable measurement region for the gas sensor from FIG. 7;

FIG. 9 is a schematic flow diagram of the steps for triggering a safety device for an above battery storage device.

### DETAILED DESCRIPTION OF THE DRAWINGS

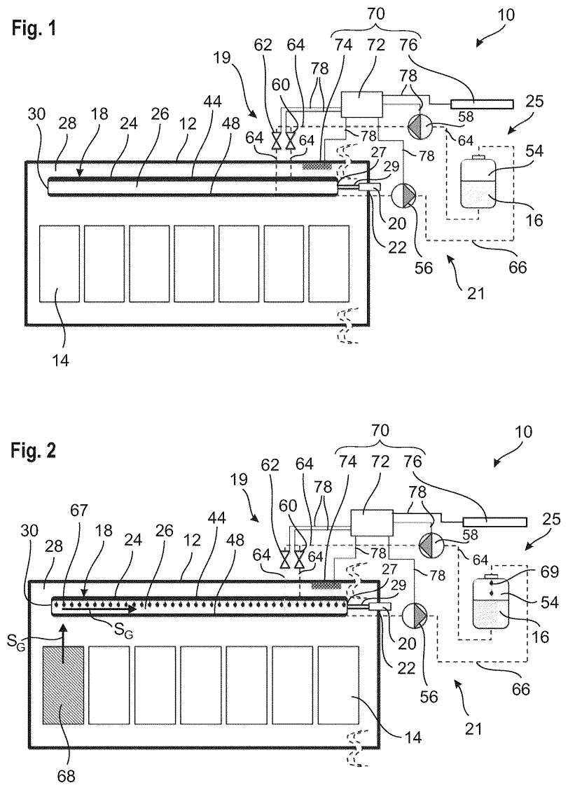

FIG. 1 shows a battery storage device 10 with a safety device 25, 70.

The battery storage device 10 further comprises a storage device housing 12. The storage device housing 12 is sealed against the escape of liquids. For controlled removal of gases, the storage device housing may also include a pressure-regulating valve or pressure relief valve (not shown here).

The storage device housing 12 has an interior 28 in which at least one battery cell 14 is disposed. It is alternatively possible for two or more battery cells 14 to be disposed in the interior 28 of the storage device housing 12. In addition, the arrangement of the battery cells 14 within the storage device housing 12 may be as desired. If two or more battery cells 14 are present, these may be interconnected in order to provide a higher voltage and energy of the battery storage device 10.

The battery cells 14 contain at least one sulfur dioxide-based electrolyte. In general, the technology is not restricted any further in relation to the battery cell 14, provided that at least one battery cell 14 in the storage device housing 12 contains sulfur dioxide as electrolyte constituent.

For example, it is possible to use battery cells 14 with electrolyte composition from WO 2021/019042A1, WO 2015/043573A2, or German patent application No. 10 2021 118 811.3, which was yet to be published at the priority date of the present application.

The safety device 25, 70 comprises a dosage device 25 and a monitoring unit 70. The dosage device 25 and the monitoring unit 70 are electrically connected to one another via connections 78, where electrical signals can be sent and received via the connections 78.

The dosage device 25 comprises a reservoir vessel 54 disposed outside the storage device housing 12, and a distributor device 18 disposed within the storage device housing 12. In particular, the distributor device 18 is connected for flow purposes to the reservoir vessel 54.

The reservoir vessel 54 contains an additive 16. In addition, the reservoir vessel 54 has an inlet opening and an outlet opening (not shown here).

The additive 16 is in an aqueous solution and comprises at least one base selected from the group of the carbonates, hydrogencarbonates, oxides and hydroxides, and combinations thereof. The base preferably takes the form of a saturated solution.

There is a sufficient amount of the additive 16 in the reservoir vessel 54 to neutralize the sulfur dioxide present in the battery cells 14. The reservoir vessel 54 contains at least an amount of the additive 16 sufficient to fully neutralize the sulfur dioxide present in at least one battery cell 14. The reservoir vessel 54 preferably contains an excess of the additive 16 in relation to the sulfur dioxide-based electrolyte present in at least one of the battery cells 14. More preferably, the reservoir vessel 54 contains an amount of the additive 16 sufficient to fully neutralize the sulfur dioxide present in all the battery cells 14.

The distributor device 18 is disposed in the interior 28 of the storage device housing 12.

The distributor device 18 comprises a dosage housing 24 that encloses an elongated cylindrical extraction chamber 26 with a longitudinal direction. The extraction chamber 26 has two mutually opposite ends in the longitudinal direction that bound the extraction chamber 26 in longitudinal direction. One end has a gas-permeable section 30 connected for flow purposes to the extraction chamber 26. The other end has an exit opening 27.

The gas-permeable section 30 is preferably designed as an entry opening closed by a gas-permeable preliminary filter (not shown here). The gas-permeable preliminary filter enables spatial separation between the extraction chamber 26 and the battery cells 14, but also a flow connection between the extraction chamber 26 and the interior 28, such that free exchange of gas can take place.

The exit opening 27 is connected for flow purposes to a channel 29, which opens in an outflow opening 22 of the storage device housing 12. The channel 29 may take the form of a continuation of the dosage housing 24 or of a continuation of the storage device housing 12. It is alternatively conceivable that the dosage housing 24 is placed directly on top of the outflow opening 22. The channel 29 is thus absent (not shown here).

The outflow opening 22 is recessed in a wall of the storage device housing 12. In addition, the outflow opening 22 is closed by a safety seal 20. The safety seal 20 is set up such that it clears the outflow opening 22 over and above a particular positive pressure within the storage device housing 12.

For example, the safety seal 20 may be designed as a pressure relief valve or a switchable valve.

The dosage housing 24 is additionally bounded transverse to the longitudinal direction by a roof 44 and a floor 48.

The roof 44 of the extraction chamber 26 has an internal distributor element 46 for release of the additive 16. The distributor element 46 may comprise, for example, a multitude of perforations or nozzles recessed into the roof.

The floor 48 of the extraction chamber 26 has a trapping element (not shown here) for collecting the additive 16.

In addition, the dosage housing 24 has an external distributor element 52 for release of the additive 16 outside the extraction chamber 26 and in the interior 28 of the storage device housing 12. The distributor element 52 may comprise, for example, a multitude of perforations or nozzles.

The distributor device 18 is connected for flow purposes to the abovementioned reservoir vessel 54, where a delivery line 19 disposed outside the storage device housing 12 and an outflow line 21 disposed outside the storage device housing 12 run between the reservoir vessel 54 and the distributor device 18.

The delivery line 19 extends away from the reservoir vessel 54 to the distributor device 18. As apparent from FIG. 1, the delivery line 19 comprises an inflow conduit 64 and a dosage pump 58, where the inflow conduit 64 connects the outlet opening (not shown here) of the reservoir vessel 54 to the dosage pump 58 for flow purposes. A further inflow conduit 64 runs from the dosage pump 58, which splits into two separate inflow conduits 64. One conduit 64 is connected to a first valve 60 for flow purposes, while the other conduit 64 is connected to a second valve 62 for flow purposes. The first valve 60 is connected to the internal distributor element 46 of the distributor device 18 for flow purposes. In parallel, the second valve 62 is connected to the external distributor element 52 of the distributor device 18 for flow purposes

Thus, the delivery line 19 connects the distributor device 18 and the reservoir vessel 54 to one another for flow purposes. The delivery line 19 serves in particular to convey the additive 16 from the reservoir vessel 54 to the distributor device 18.

The outflow line 21 extends away from the distributor device 18 in the opposite direction from the delivery line 19 and toward the reservoir vessel 54.

The outflow line 21 comprises a backflow conduit 66 and an outflow pump 56, where the backflow conduit 66 connects the outlet opening (not shown here) of the reservoir vessel 54 to the outflow pump 56 for flow purposes. The outflow pump 56 is in turn connected for flow purposes via a further backflow conduit 66 to the trapping element (not shown here) of the floor 48 of the extraction chamber 26.

The outflow line 21 ensures reverse transport of the additive 16 after release from the distributor device 18 to the reservoir vessel 54.

In addition, the safety device 25, 70 of the battery storage device 10 has a monitoring unit 70.

The monitoring unit 70 comprises a battery control system 72 comprising a sensor unit 74 which is connected to the battery control system 72 and is disposed within the storage device housing 12. In addition, the battery control system 72 comprises a pre-crash sensor 76 disposed outside the storage device housing 12.

The sensor unit 74 may be disposed as desired within the storage device housing 12. It is therefore conceivable that the sensor unit 74 is fixed on an inner wall of the storage device housing 12. The sensor unit 74 may alternatively be secured directly to a battery cell 14.

In one variant of the technology, it is also possible for two or more sensor units 74 to be disposed at any desired sites within the storage device housing 12. It is thus possible for various regions of the battery storage device 10 to be sensorily monitored by the sensor unit 74.

The technology is not subject to any further restriction in relation to the sensor unit 74. It is possible to use any of the sensor units customary in the art that are capable of detecting a pressure difference, temperature difference or difference in the atmosphere.

The sensor unit 74 is preferably a sensor for selective detection of sulfur dioxide, preferably of gaseous sulfur dioxide in an atmosphere. For this purpose, it is possible to use any of the sensors known in the art.

For example, it is possible to use an indicator known from U.S. Pat. No. 4,222,745 for detection of escaping sulfur dioxide from a battery. This consists of potassium dichromate adsorbed on finely divided silicon dioxide and of an adhesive polymeric material, for example polydimethylsiloxane as stabilizing matrix. For intense color perception, it is also possible to add titanium dioxide. This indicator changes color on contact with sulfur dioxide.

Also conceivable is a detector, known from WO 02 079 746, consisting of pulverulent potassium dichromate which is applied on an adhesive strip together with an oxidation accelerator and a metal oxide inhibitor, which enables detection of sulfur dioxide inter alia.

Also known is a sensor from U.S. Pat. No. 6,579,722 for detection of gaseous sulfur dioxide, in which a chemiluminescent reagent is immobilized in a polymer film. Chemiluminescence as a result of contact with sulfur dioxide is detected with the aid of a photomultiplier or a photoelectric element.

It is likewise possible to use a sensor from JP 2003035705, which is suitable for sulfur dioxide detection in a gaseous sample, in which optical transmittance in the UV/VIS/IR range under the action of the analyte is monitored. The sensor consists of a combination of Orange 1 and amines, and a combination of iron ammonium sulfate, phenanthroline and acids.

A sensor is likewise known from EP 0 585 212, which is designed as a sensor membrane for detection of sulfur dioxide. For this purpose, transition metal complexes with ruthenium, osmium, iridium, rhodium, palladium, platinum or rhenium as central atom, 2,2′-bipyridine, 1,10-phenanthroline or 4,7-diphenyl-1,10-phenanthroline as ligands, and perchlorate or chloride or sulfate as counterion are used. The polymer matrix comes from the group of the cellulose derivatives, the polystyrenes, the polytetrahydrofurans or derivatives thereof.

It is also possible to utilize a sensor from EP 0 578 630, which provides a sensor membrane of optical sensors for detection of sulfur dioxide. For this purpose, pH indicators, such as the fluorescent dye quinine or the absorptive dye bromocresol purple, with counterions such as long-chain sulfonate ions or ammonium ions with long-chain radicals, are immobilized on a polymer matrix of polyvinylchloride.

More preferably, an optical sensor is utilized for selective detection of gaseous sulfur dioxide.

For example, it is possible to utilize an optical sensor as known from “Optical sensors for dissolved sulfur dioxide” (A. Stangelmayer, I. Klimant, O. S. Wolfbeis, Fresenius J. Analytical Chemistry, 1998, 362, 73-76). For detection of gaseous sulfur dioxide, lipophilic pH indicators in the form of ion pairs immobilized in a gas-permeable silicone or OsmoSil membrane are used as sulfur dioxide sensors for gaseous samples. pH indicators used here are ditetraalkyl-ammonium salts with long-chain alkyl radicals of bromothymol blue, bromocresol purple and bromophenol blue. The measurement parameter used is the absorption of light in the UV/VIS region.

It is also possible to utilize an optical sensor for quantitative determination of sulfur dioxide in a sample, as known from DE 10 2004 051 924A1. The sensor proposed here contains an indicator substance immobilized homogeneously in a matrix of the transparent sensor, which comes into at least indirect contact with the sample and changes concentration in the presence of sulfur dioxide. This change in concentration of the indicator substance can be monitored photometrically as the change in transmittance in the UV/VIS region of the sensor.

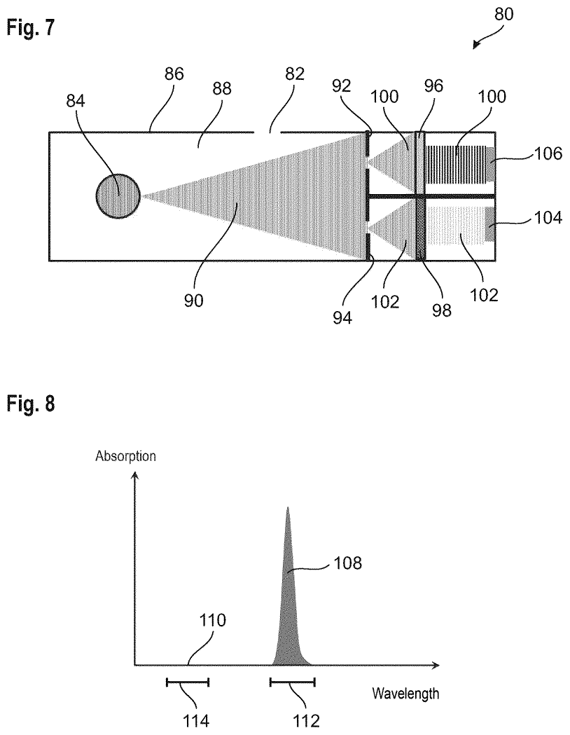

In a particularly preferred variant, the sensor for selective detection of sulfur dioxide is a sensor as described in FIG. 7.

The sensor unit 74 is set up to detect the escape of the electrolyte from a battery cell 14, to create data therefrom and to pass them on to the battery control system 72. The transmission of the data is accomplished via an electrical connection 78.

The pre-crash sensor 76 may be disposed as desired. In general, the technology is not subject to any further restriction in relation to the pre-crash sensor 76. In principle, it is possible to use any pre-crash sensors capable of detecting an impending collision with a physical object.

The battery control system 72 has electrical connections 78 to the pre-crash sensor 76, the dosage pump 58, the outflow pump 56, the sensor unit 74, the first valve 60 and the second valve 62. The battery control system 72 is also set up to receive data from the sensor unit 74 and the pre-crash sensor 76 via the connections 78 and to evaluate these with regard to a trigger or non-trigger scenario.

If the battery control system 72 receives abnormal data with regard to a temperature, a change in pressure or a change in atmosphere within the storage device housing 12 via the sensor unit 74, the battery control system will trigger a trigger scenario with a first dosage state.

If the battery control system 72 additionally receives data from the pre-crash sensor 76 that indicates an impending collision with another physical object, the battery control system 72 will trigger a trigger scenario with a second dosage state. The trigger scenario with the second dosage state is preferably triggered only at a particular severity of the shortly impending collision, such that, in the case of a gentle collision, the complete battery storage device 10 is not unnecessarily flooded with the additive. For this purpose, a threshold value can be defined for the expected collision, which is stored in the battery control system 72 and is regularly compared in the course of operation with the data received from the pre-crash sensor 76.

It is thus possible for the battery control system 72 to classify the trigger scenario into different degrees of severity.

FIG. 2 shows the battery storage device from FIG. 1 in the case of a trigger scenario with a first dosage state.

In addition, FIG. 2 contains the same components as already described in FIG. 1.

The mechanism of a trigger scenario with a first dosage state will be described hereinafter with reference to FIG. 2.

In the event of an electrical, thermal, mechanical or chemical defect in a battery cell 14, it may be the case under some circumstances that the cell in question is opened. Such a battery cell 14 is thus a defective cell 68. In such a case, there will inevitably be a change in a parameter in the interior of the storage device housing 12, for example temperature or pressure or atmosphere composition. A change in this parameter is detected by the sensor unit 74.

In the case of cell opening of a defective cell 68, it may be the case that a sulfur dioxide-based electrolyte will escape. The electrolyte may enter the interior 28 of the storage device housing 12 either in liquid or gaseous form. The sensor unit 74 detects the presence of such a gaseous electrolyte within the storage device housing 12 in the form of parameters at variance, as already described above. These are passed on to the battery control system 72 as abnormal parameters in the form of data.

The battery control system 72 compares the data obtained continually to the expected data. If a predefined variance in the data obtained from the data expected is found, the battery control system 72 will trigger a trigger scenario. In such a scenario, the distributor device 18 switches into a first dosage state. At the same time, the battery control system 72 awaits data from the pre-crash sensor 76. If the battery control system 72 does not receive any data from the pre-crash sensor 76, no impending collision with another physical object is expected and the distributor device remains in the first dosage state.

In the first dosage state, the battery control system 72 will merely take measures for control of local damage to the battery storage device 10. The battery control system 72 activates the outflow pump 56 and the dosage pump 58 via electrical connections 78, and opens the first valve 60. The second valve 62 remains closed. Subsequently, the dosage pump 58 withdraws the additive 16 from the reservoir vessel 54 and conducts it via the inflow conduit 64 and via the open valve 60 into the internal distributor element 46 of the distributor device 18. The internal distributor element 46 releases the additive 16 within the extraction chamber 26.

A sulfur dioxide-based electrolyte that escapes from a defective cell 68 will accumulate in the interior of the storage device housing 12 with time. In this way, a positive pressure will build up within the storage device housing 12. Over and above a particular positive pressure, the safety seal 20 will clear the outflow opening 22, such that the positive pressure can be released into the environment. As a result, a flow direction will be defined in the interior 28, such that the gaseous electrolyte constituents have a flow direction S_{G} in the direction of the outflow opening 22. The gaseous electrolyte constituents with the flow direction S_{G} pass through the gas-permeable section 30 into the extraction chamber 26 of the distributor device 18. The gaseous electrolyte constituents come into contact there with the additive 67 released. An acid-base neutralization takes place between the additive 67 released and the electrolyte. The gas stream S_{G} of the electrolyte passes through the extraction chamber 26 in longitudinal direction in order to arrive at the exit opening 27, which is connected to the outflow opening 22 by the channel 29. The cleaned atmosphere of the storage device housing can enter the environment of the battery storage device 10 via the outflow opening 22.

In the extraction chamber 26, excess constituents of the additive 67 released and neutralized constituents of the electrolyte can be led off via a trapping element (not shown here) recessed in the floor 48 of the extraction chamber 26. They are led off via a backflow conduit 66 to an outflow pump 56. The outflow pump 56 returns the collected constituents to the reservoir vessel 54. In this way, excess additives can be collected and recycled.

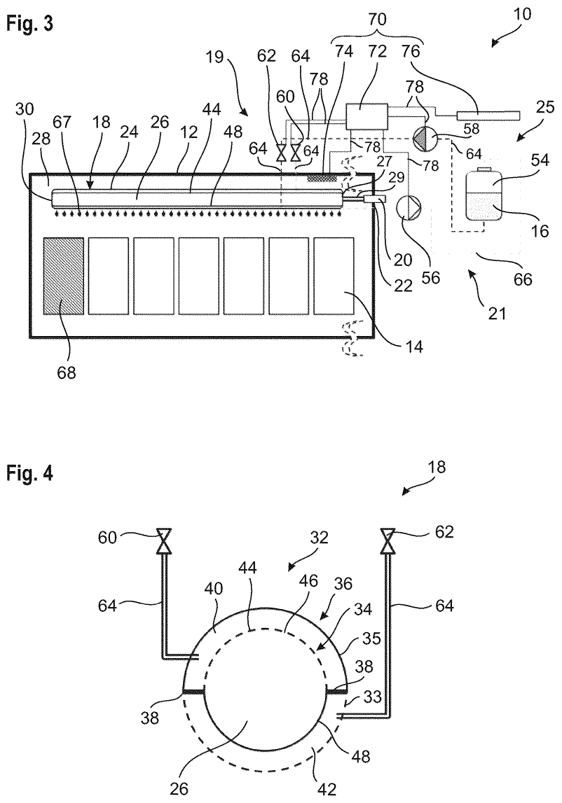

FIG. 3 shows the battery storage device from FIG. 1 in the case of a trigger scenario with a second dosage state.

In addition, FIG. 3 shows the same constituents of the battery storage device 10 as already described in FIGS. 1 and 2.

There follows a description of a trigger scenario with a second dosage state with reference to FIG. 3.

The switchable distributor device 18 is switched into a second dosage state when there is an expectation from the pre-crash sensor 76 of damage with external effects, for example as a result of an impending collision with another physical object, as well as a defective battery cell 68 in the storage device housing 12. However, it may also be the case that a particularly large number of battery cells 14 within the storage device housing 12 are defective. In both the cases mentioned, the battery control system 72 will expect damage with external effects from the battery storage device 10. In that case, a trigger scenario with a second dosage state is chosen.

In a second dosage state, the battery control system 72 activates the dosage pump 58 and opens the second valve 62. The outflow pump 56 and the first valve 60 remain closed in the second dosage state. Thus, the dosage pump 58 withdraws the additive 16 from the reservoir vessel 54 via the inflow conduit 64 and supplies the additive via the second valve 62 to the external distributor element 52 of the distributor device 18. The external distributor element 52 releases the additive 16 outside the extraction chamber 26 into the interior 28 of the storage device housing 12.

The additive 67 released can thus come into direct contact with the escaping sulfur dioxide-based electrolyte and react therewith in an acid-base neutralization reaction. In the second dosage state, in particular, whole contents of the reservoir vessel 54 are released in the interior 28 of the storage device housing 12 without feeding the additive 67 released back to the reservoir vessel 54. In contrast to the first dosage state, the second dosage state is therefore not usable repeatedly. A battery storage device 10 with a distributor device 18 in which a trigger scenario with a second dosage state has been triggered is accordingly no longer usable for operation.

FIG. 4 shows a cross-sectional view of a switchable distributor device 18.

The switchable distributor device 18 has an elongated cylindrical and central double tube 32 with a longitudinal direction. As apparent from FIG. 4, the longitudinal direction is in the plane of the drawing.

The double tube 32 contains an outer tube 36 and an inner tube 34 disposed within the outer tube 36. The inner tube 34 is coaxial relative to and disposed within the outer tube 36 in relation to a tube axis. In addition, the inner tube 34 encloses a circular cylindrical extraction chamber 26 that extends in the longitudinal direction of the double tube 32.

The inner tube 34 and the outer tube 36 are spaced apart from one another such that there is an annular interspace between them. The outside of the inner tube 34 is secured on the inside of the outer tube 36 by a connecting portion 38 formed continuously in the direction of the tube axis. In addition, the connecting portion 38 divides the annular interspace equatorially into an upper chamber 40 and a lower chamber 42. The upper chamber 40 and the lower chamber 42 are spatially separated by the continuous connecting portion 38.

The upper chamber 40 is connected for flow purposes to the first valve 60 by an inflow conduit 64. The lower chamber 42 is connected for flow purposes to a second valve 62 via a further inflow conduit 64.

The inner tube 34 is composed of an upper and a lower half-shell. The two half-shells are preferably bonded to one another in a gastight manner, especially welded.

The upper half-shell of the inner tube 34 comprises a roof 44, where the roof 44 has an internal distributor element 46. The internal distributor element 46 is set up to connect the upper chamber 40 to the extraction chamber 26 for flow purposes. For example, the internal distributor element 46 may be designed as a perforated wall. It is alternatively conceivable that the internal distributor element 46 is designed in the form of nozzles for nebulization of the additive 67 released.

The lower half-shell of the inner tube 34 comprises a floor 48 with a trapping element (not shown here). The trapping element may, for example, be a sink, a groove or a drain which is connected by the backflow conduit (not shown here) to the outflow pump (not shown here) for flow purposes. The trapping element preferably has an assigned filter in order to keep solids away from the backflow conduit and the outflow pump. The trapping element may optionally further comprise an adsorbent (not shown here) that at least partly adsorbs the additive 67 released and electrolyte constituents. The adsorbent may be disposed, for example, in the groove or in the drain. The technology is not subject to any further restriction in relation to the adsorbent. In principle, it is possible to use any adsorbents available in the art that are capable of binding the additive and constituents that have reacted therewith.

The outer tube 36 has an opposite construction to the inner tube 34. The outer tube 34 is likewise composed of an upper and a lower half-shell. The two half-shells are preferably bonded, especially welded, to one another in a gastight manner.

The upper half-shell of the outer tube 36 comprises an upper outer wall 35 in a gas-and liquid-tight design.

The lower half-shell of the outer tube 36 comprises a lower outer wall 33 with an outer distributor element 52, where the outer distributor element 52 is set up to connect the lower chamber 42 to the interior 28 of the storage device housing 12 for flow purposes. For example, the outer distributor element 46 may be designed as a perforated wall. Alternatively, it is conceivable that the outer distributor element 52 is designed in the form of nozzles for nebulization of the additive 67 released.

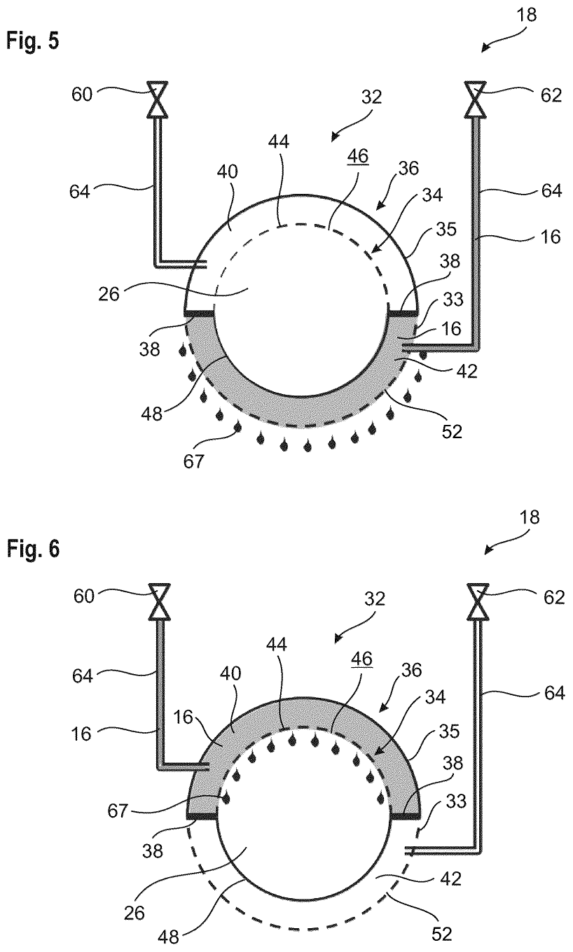

FIG. 5 shows the distributor device 18 from FIG. 4 in the case of a trigger scenario with a second dosage state.

In addition, FIG. 5 contains the same components as already described in FIG. 4.

In the case of a trigger scenario with a second dosage state, the first valve 60 remains closed, and the second valve 62 is opened, such that the additive 16 can flow via the inflow conduit 64 into the lower chamber 42. The lower chamber 42 is preferably completely filled by the additive 16 and is pressurized by the dosage pump 58.

An additive 16 present in the lower chamber 42 can thus be released via the outer distributor element 52. The additive 67 released can then neutralize any sulfur dioxide-based electrolyte present in the interior 28.

FIG. 6 shows a distributor device 18 from FIG. 4 in the case of a trigger scenario with a first dosage state.

In addition, the same descriptions of the components as already set out in FIG. 4 are applicable.

In the case of a trigger scenario with a first dosage state, the first valve 60 is opened, such that the additive 16 can get into the upper chamber 40 via the inflow conduit 64. The upper chamber 40 is thus filled by the additive 16. The additive 16 can leave the upper chamber 40 via the internal distributor element 46 and enter the extraction chamber 26 selectively under pressure.

Gaseous constituents of the sulfur-dioxide-based electrolyte that are present in the extraction chamber 26 come into direct contact with the additive 67 released, which results in neutralization of these. Typically, the neutralized constituents and excess additive 16 are precipitated on the floor 48 of the inner tube 34, where they can be collected by the trapping element (not shown here) and recycled into the reservoir vessel.

FIG. 7 shows a gas sensor 80 for sulfur dioxide-based on a two-beam spectrometer.

The gas sensor 80 has a detector chamber 88 enclosed by a detector housing 86. In addition, the detector housing 86 has a gas inlet opening 82.

The gas inlet opening 82 connects the detector chamber 88 to the interior 28 of the storage device housing 12 for flow purposes. As a result, free exchange of gas can take place, and an exiting electrolyte in the storage device housing 12 can be detected by the gas sensor 80.

The detector housing 86 has an elongated form, with a light source 84 assigned to one end within the housing.

The light source 84 is preferably an infrared light source, more preferably a near infrared light source. The technology is not restricted in relation to the infrared light source. It is possible to use any of the IR light sources known in the art, provided that these are capable of emitting wavelengths suitable for detection of sulfur dioxide in a gas atmosphere.

The light source 84 preferably emits wavelengths in the range between 400-1800 cm⁻¹, more preferably between 450-600 cm⁻¹, 1100-1200 cm⁻¹ and/or 1300-1400 cm⁻¹. In operation, the light source 84 emits an NIR beam 90 with a continuous spectrum of wavelengths within the abovementioned range.

The NIR beam 90 emitted by the light source 84 is divided into two spatially separate NIR rays by a measurement beam stop 92 disposed in the detector chamber 88 and a reference beam stop 94. More specifically, the NIR beam 90 is split by the measurement beam stop 92 into a measurement beam 100 and by the reference beam stop 94 into a reference beam 102. Thus, the stops create two separate beam paths.

The measurement beam 100, after passing the measurement beam stop 92, hits a measurement beam filter 96. The reference beam 102, after passing the reference beam stop 94, hits a reference beam filter 98.

Suitable measurement beam filters 94 and reference beam filters 98 are, for example, bandpass filters, preferably narrowband filters. For example, the bandpass filter may have a bandwidth of 10-0.2 nm, preferably 5-0.2 nm, more preferably 2 -0.2 nm. These are thus capable of filtering a predetermined wavelength selectively out of the reference beam 102 and the measurement beam 100.

The reference chosen is the transmission region of the reference beam filter 98 such that it is transparent in a narrow region of the spectrum in which neither sulfur dioxide nor other molecules, for example carbon dioxide or water vapor, have absorption bands.

For the measurement beam filter 96, i.e. that of the measurement beam 100, the transmission region is chosen such that it is within a range where only sulfur dioxide absorbs, but no other gases that could distort the measurement signal.

Examples of suitable wavelengths of the measurement beam filter are: 1.56 μm, 1.57 μm, 1.58 μm, 2.46 μm and 4.02 μm.

After passing the measurement beam filter 96, the measurement beam 100 hits a measurement beam detector 106 downstream of the measurement beam filter 96. Analogously, the reference beam 102 hits a reference beam detector 104 downstream of the reference beam filter 98.

Examples of suitable detectors for detection of the wavelengths transmitted by the filters are detectors based on thermocouples. These are capable of converting a thermal energy directly to an electrical energy, which means that very small thermal voltages can be generated and hence detected. The detectors thus used thus work in a particularly precise manner and are suitable for the detection even of small amounts of sulfur dioxide in an atmosphere.

FIG. 8 shows a measurement region of a sulfur dioxide sensor from FIG. 7, where an absorption is plotted against a wavelength. What is shown is the cumulated absorption of the measurement beam detector and the reference beam detector 106, 104.

The measurement beam detector 106 detects the measurement signal 108 in a measurement wavelength range 112, while the reference beam detector 104 detects the reference signal 110 in a reference wavelength range 114. The reference wavelength range 114 and measurement wavelength range 112 are predetermined by the choice of beam filters. The width of the wavelength ranges measured is likewise dependent on the choice of beam filter and is generally 10-0.2 nm, preferably 5-0.2 nm, more preferably 2 -0.2 nm.

If the measurement beam detector 106 detects a measurement signal 108, sulfur dioxide is present in the atmosphere of the detector chamber 88 and hence also in the interior of the storage device housing 12. For a positive detection of sulfur dioxide, it is possible to define a threshold value which is typically above the background noise of the detector.

The advantage of the two-beam spectrometers shown is that these are compact and hence can be accommodated in a space-saving manner within the storage device housing 12. In addition, sulfur dioxide is detected in a spectroscopic manner, which facilitates evaluation and conversion to electronic information by comparison with conventional methods.

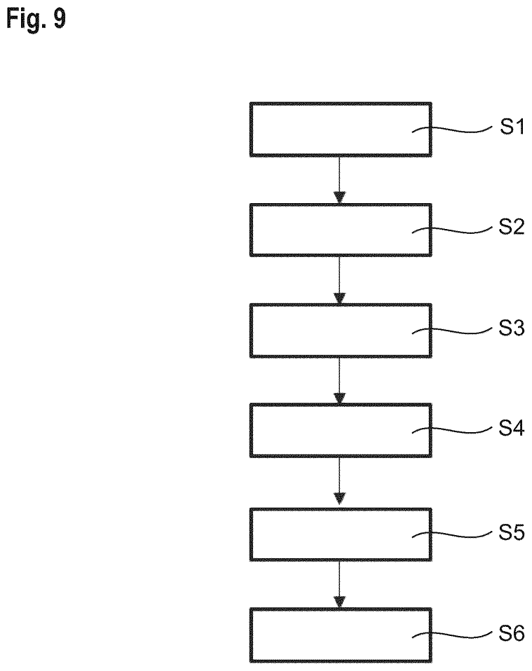

FIG. 9 shows a schematic flow diagram of the steps of a method of triggering a safety device for an above battery storage device 10.

In the first step, the sensor unit detects an electrolyte exiting from a battery cell within the storage device housing and/or a pre-crash sensor recognizes an impending collision of the vehicle with another physical object (step 1). The pre-crash sensor and the sensor unit create data from both events and pass these on to the battery control system.

Subsequently, the battery control system evaluates the data with regard to the existence of a trigger or non-trigger scenario (step 2).

If a trigger scenario exists according to assessment of the data, the battery control system recognizes a trigger scenario (step 3).

Thereafter, the battery control system classifies the trigger scenario into different degrees of severity (step 4). The degrees of severity depend on various factors, for example the concentration of the electrolyte within the storage device housing, the number of defective cells within the storage device housing and/or the type of expected collision with another physical object.

In the last step, the safety device triggers the trigger scenario by the actuation of the dosage device, such that the dosage device switches the switchable distributor device into a first or second dosage state, where the first dosage state releases the additive within the distributor device, and where the second dosage state releases the additive outside the distributor device and within the interior of the storage device housing (step 5).

1-12. (canceled)

13. A battery storage device comprising:
a storage device housing and one or more battery cells disposed in an interior of the storage device housing, each battery cell containing a sulfur dioxide-based electrolyte; and
a safety device with a dosage device, the dosage device comprising:
an additive for neutralizing the electrolyte; and
a switchable distributor device disposed in the interior of the storage device housing and being configured for release of the additive, the switchable distributor device being selectively switchable into a first or second dosage state, wherein
the first dosage state comprises a release of the additive within the switchable distributor device, and
the second dosage state comprises a release of the additive outside the switchable distributor device into the interior of the storage device housing.

14. The battery storage device according to claim 13, wherein
the storage device housing has an outflow opening closed by a safety seal,
the safety seal is configured to clear the outflow opening on attainment of a predetermined positive pressure, and
the switchable distributor device is coupled to the outflow opening.

15. The battery storage device according to claim 13, wherein
the switchable distributor device has a dosage housing with an extraction chamber fluidly connected to the interior of the storage device housing via at least one gas-permeable section.

16. The battery storage device according to claim 15, wherein
the extraction chamber comprises a roof having an internal distributor element for releasing the additive and a floor having a trapping element for collecting the additive released, and
where the dosage housing has an external distributor element for releasing the additive outside the extraction chamber and into the interior of the storage device housing.

17. The battery storage device according to claim 16, wherein
the dosage device comprises a reservoir vessel containing the additive and an outflow pump connected to the reservoir vessel and a dosage pump.

18. The battery storage device according to claim 17, wherein
the dosage pump is connected via a first valve to the internal distributor element and via a second valve to the external distributor element.

19. The battery storage device according to claim 17, where the outflow pump is fluidly connected to the trapping element and the reservoir vessel.

20. The battery storage device according to claim 18, wherein, in the first dosage state,
the additive is withdrawn from the reservoir vessel by the dosage pump and is released within the extraction chamber via the first valve and the internal distributor element,
after the release, gaseous electrolyte constituents based on sulfur dioxide are neutralized by the additive as they pass through the extraction chamber, and
after the neutralization, the additive and the gaseous electrolyte constituents are collected by the trapping element and returned to the reservoir vessel via the outflow pump.

21. The battery storage device according to claim 18, wherein, in the second dosage state,
the additive is conducted out of the reservoir vessel by the dosage pump and released via the second valve and the external distributor element in the interior of the storage device housing.

22. The battery storage device according to claim 13, wherein the safety device has a monitoring unit comprising:
a battery control system;
a pre-crash sensor; and
a sensor unit connected to the battery control system and positioned within the storage device housing.

23. The battery storage device according to claim 22, wherein the sensor unit is selected from the group consisting of an optical sensor, a pressure sensor, a temperature sensor, and a chemical sensor.

24. The battery storage device according to claim 23, wherein
the sensor unit comprises a spectroscopic gas sensor for detecting gaseous sulfur dioxide.

25. The battery storage device according to claim 22, wherein
the sensor unit is configured to detect an electrolyte escaping from the one or more battery cells and the pre-crash sensor is configured to detect an impending collision with another object, whereby data are compiled and passed on by the battery control system for evaluation with regard to a trigger or non-trigger scenario.

26. The battery storage device according to claim 25, wherein
the battery control system is configured to classify the trigger scenario into different degrees of severity.

27. The battery storage device according to claim 26, wherein
the battery control system, in the event of a trigger scenario, is configured to actuate the dosage device and switch the switchable distributor device into a first or second dosage state depending on the severity.

28. A method of triggering a safety device for a battery storage device, the method comprising:
providing the battery storage device according to claim 22;
detecting escape of the electrolyte from any of the one or more battery cells within the storage device housing via the sensor unit of the monitoring unit and/or detecting an impending collision of a vehicle with a physical object via the pre-crash sensor;
evaluating the data via the battery control system with regard to the existence of a trigger or non-trigger scenario;
recognizing the existence of a trigger scenario;
classifying the trigger scenario into different degrees of severity; and
triggering the safety device by actuating the dosage device, whereby the dosage device switches the switchable distributor device into the first or the second dosage state, wherein
the first dosage state releases the additive within the switchable distributor device, and
the second dosage state releases the additive outside the switchable distributor device into the interior of the storage device housing.
